(19) United States
(12) Patent Application Publication
(10) Pub. No.: US 2007/0168942 A1
(43) Pub. Date: Jul. 19, 2007

(54) Working method for treatment of abstract objects of the computer system of AI of a cyborg or an android

(76) Inventor: Boris Kaplan, Munich (DE)

Correspondence Address: Mr. Boris Kaplan, Guardinistr. 160, Munich, 81375, DE

(21) Appl. No.: 11/368,422

(22) Filed: Mar. 7, 2006

(30) Foreign Application Priority Data
Nov. 17, 2005 (DE) DE102005054901

(51) Int. Cl. G06F 9/44; G06F 9/45

(52) U.S. Cl. 717/108; 717/104; 717/136

(57) ABSTRACT

The working method for the treatment of an abstract object of the computer system of Al of a Cyborg or an Android in which the internal directives of the abstract subjectivity of the computer system are used. With the working method more than ten internal directives can be used.

The present invention refers to the working method for treatment of abstract objects of the computer system of Al of a cyborg or an android. The system is based on a natural language.

By the European patent (KR 2003000254, DE 10361726), a robot toy with artificial intelligence and control method for it is patented. Several patent claims specific for a robot are disclosed by the patent. The Al of the robot toy is planned for its mechanical control.

Further, the humanoid robots are known which can move in human or animal way.

For example, ASIMO is a robot developed by company Honda which can move in human way.

The AIBO of company Sony, a robot-dog, which can be programmed. In addition, he can run, see, show his feelings and speak the predefined words.

The QRIO of company Sony. It is a humanoid robot itself, which can move in human way. He can do everything that the AIBO can do. He can also speak about something, or have a conversation. Besides, the speech recognition is used and the predefined response scenarios with many thousands of words are prepared. In addition, the ORIO is very expensive.

With the concept definition artificial intelligence, (AI), the so-called strong AI is known worldwide. The human intelligence should be imitated with the strong AI. The strong AI, that can work like the human intelligence, should be created on the basis of consciousness, self-confidence, emotions etc. The strong AI is treated as an illusion at present.

In addition, the terms: emotional intelligence, emotions in fauna, emotional behavioral control; subjective feeling; the mood etc. are known worldwide. All these terms are taken into consideration with the strong AI, and/or are researched for the strong AI. Several of these terms can also be summarized under the term, associative subjectivity.

Some terms need to be defined for describing the present invention. The terms, and their definitions, include:
1. “An android is an artificially created robot, an automation, that resembles a human being . . . in . . . behavior. The word derives from the Greek andr-, “meaning “man, male”, and the suffix -eides, used to mean “of the species alike” (from eidos “species”).”—Wikipedia, the free encyclopedia. htm (http://en .wikipedia.org/wiki/Android);
2. “The term cyborg, a portmanteau of cybernetic organism, is used to designate an organism which is a mixture of organic and mechanical (synthetic) parts . . . . Isaac Asimov's short story “The Bicentennial Man” explored cybernetic concepts . . . . His explorations lead to breakthroughs in human medicine via artificial organs and prosthetics.” As well as to the “ . . . artificial positronic brain . . . . Generally, the term “cyborg” is used to refer to a man or woman with bionic, or robotic, implants.”—Wikipedia, the free encyclopedia. htm (http://en.wikipedia.org/wiki/Cyborg);
3. “according to strong AI, the computer is not merely a tool in the study of the mind; rather, the appropriately programmed computer really is a mind” (J. Searle in Minds, Brains and Programs. The Behavioral and Brain Sciences, vol. 3, 1980).”—Wikipedia, the free encyclopedia.htm (http://en.wikipedia.org/wiki/strong_AI);
4. “The mind is the term most commonly used to describe the higher functions of the human brain . . . —Wikipedia, the free encyclopedia.htm (http://en.wikipedia.org/wiki/Mind).

This invention, as also my invention “A computer system and the working method of this computer system of artificial intelligence of a cyborg or an android”, is based on one of my scientific discoveries, and/or a theory of subjectivity, with the subject—“Human intelligence. Natural intelligence. The functionality of the human (natural) intelligence.”

Both inventions make it possible either the conversion of a humanoid robot into an android or the conversion of a human into a cyborg with the artificial component, or with the artificial part,—the artificial intelligence.

An enormous gigantic job potential, which includes thousands of highly qualified, highly motivated, high-quality jobs in the different branches, is hidden behind this invention. For example:

1. cyborg (android)—hardware development;

2. cyborg (android)—software development;

3. cyborg (android)—production;

4. cyborg (android)—pedagogy;

5. cyborg (android)—education;

6. human (cyborg (android))—medicine;

7. human (cyborg (android))—fight against crime;

8. human (cyborg (android))—counterterrorism . . .

Another strategically or political, also negative use, (if the negative internal directives of the abstract subjectivity are used), is not to exclude, for example, a cyborg assassin as a suicide bomber. It should always be taken into consideration, as well as the means of protection should be planed in advance.

The way of posing a problem of this invention is:
1. to realize a working method, with witch the computer system of AI of a cyborg or an android is impelled by itself to react to every incoming abstract object;
2. to implement a working method, with witch the computer system of AI of a cyborg or an android will decide whether the incoming abstract object will be treated by the computer system;
3. to implement a working method, with witch the computer system of AI of a cyborg or an android will decide how the computer system will treat the incoming abstract object;
4. the substantiate that the strong AI is no illusion, but it is reality;
5. to develop the strong AI peacefully, positively, as friendly towards human, as also to plan the means of protection for a negative development in advance.

The innovative solution accomplished by the present invention is that the incoming abstract object is compared in a permanent loop-mode with the internal directives of the abstract subjectivity. The loop-mode can be implemented with a loop, a thread, an application and/or a hardware device, for example, a microcontroller or another chip. The internal directives of the abstract subjectivity of the computer system of AI of a cyborg or an android are also, naturally, the abstract objects, as well as they are defined by the computer system itself, for example, as a result of a communication with the representative of the internal directives. If the equivalence of the incoming abstract object is true to a group of the internal directives, or to objects derived from the directives of the group, the incoming abstract object will be treated accordingly. If it is not true, the equivalence of the incoming abstract object will be checked to another group of the internal directives. If it is also not true, the next test will come into question. And so far up to the end of the group of the directives. Of course, a “default” scenario can also be implemented, for example, “with nothing to do”. The next loop-iteration comes either with timeout or as a reaction to a message that a new abstract object has arrived. Thus, the computer system of AI of a cyborg or an android is impelled by itself to react to every incoming abstract object.

The test can be implemented in the following way:

The equivalence test of the incoming abstract object, which contains a question, with a group of the internal directives, which contains an object “Love.whom” of the class “Love” as a directive, is delegated to the equivalence test of the incoming abstract object with the object “Help.whom” of the class “Help”, (because the class “Help” is derived from the class “Love” in the classification tree of the computer system of AI of the cyborg or the android). If the equivalence test is true, and if all other directives of the group are equal to the incoming abstract object, it will guide to a treatment-scenario. Thus, the computer system of AI of the cyborg or the android will decide whether an abstract object is to be treated and how the abstract object is to be handled within the bounds of the determined treatment mode.

The treatment mode itself is determined with the polymorphism of the classes classification of the computer system of AI of the cyborg or the android. The common attribute, doing =“communicating”, comes into question by the determination. As a result, it will be issued an answering-scenario. Thus, the computer system of AI of the cyborg or the android decides how (with witch treatment mode) the computer system will treat the incoming abstract object.

This decision can be checked with the classification tree of the computer system of AI of the cyborg or the android. (Whether the class “Answer” is really derived from class “Help”).

The equivalence test of the incoming abstract object, which contains a request, passes by the same logic to the treatment with an execute-scenario.

The equivalence test of the incoming abstract object, which contains a command, leads by the same logic to the treatment with an execute-scenario.

The equivalence test of the incoming abstract object, which contains a statement, guides by the same logic to the treatment with a note-scenario.

Etc . . .

It is a matter of course, an abstract object can also come in from the cyborg or the android himself, for example, during a think-scenario.

(It is repeated because it is very important.)

Another strategically or political, also negative use, (if the negative internal directives of the abstract subjectivity are used), is not to exclude, for example, a cyborg assassin as a suicide bomber. It should always be taken into consideration, as well as the means of protection should be planed in advance.

Other details, features and advantages result from the execution examples shown in the drawings, and from the independent und dependent claims. The execution examples follow the description.

In the drawings:

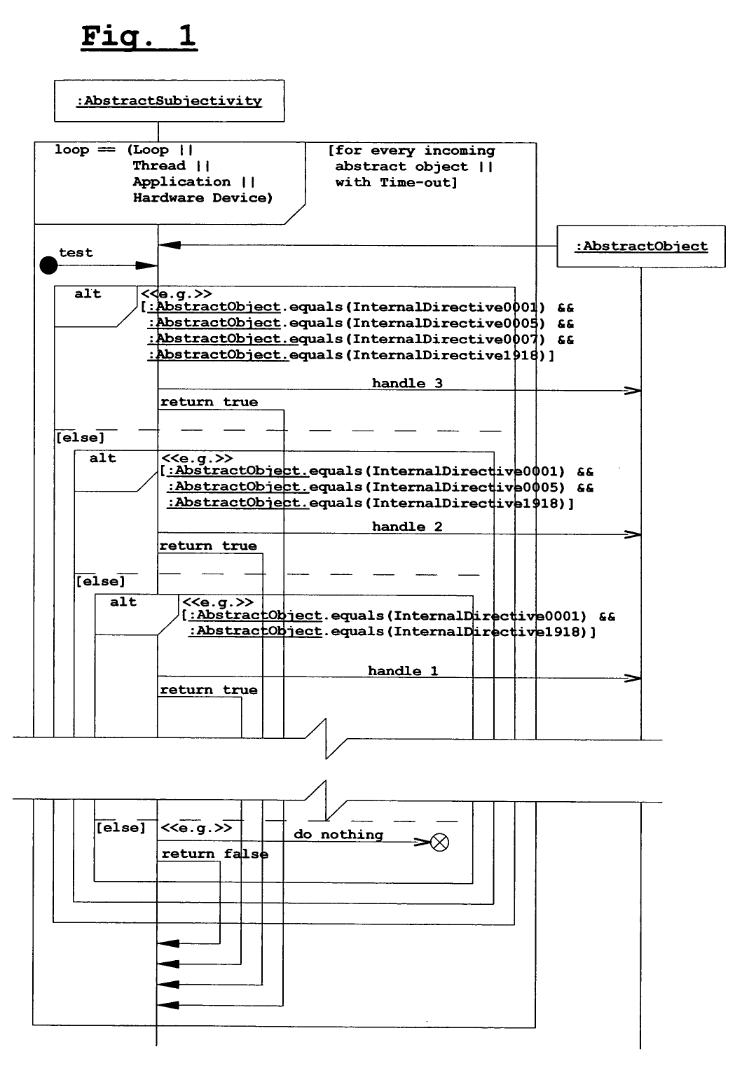

FIG. 1 illustrates the working method for treatment of abstract objects of the computer system of AI of a cyborg or an android.

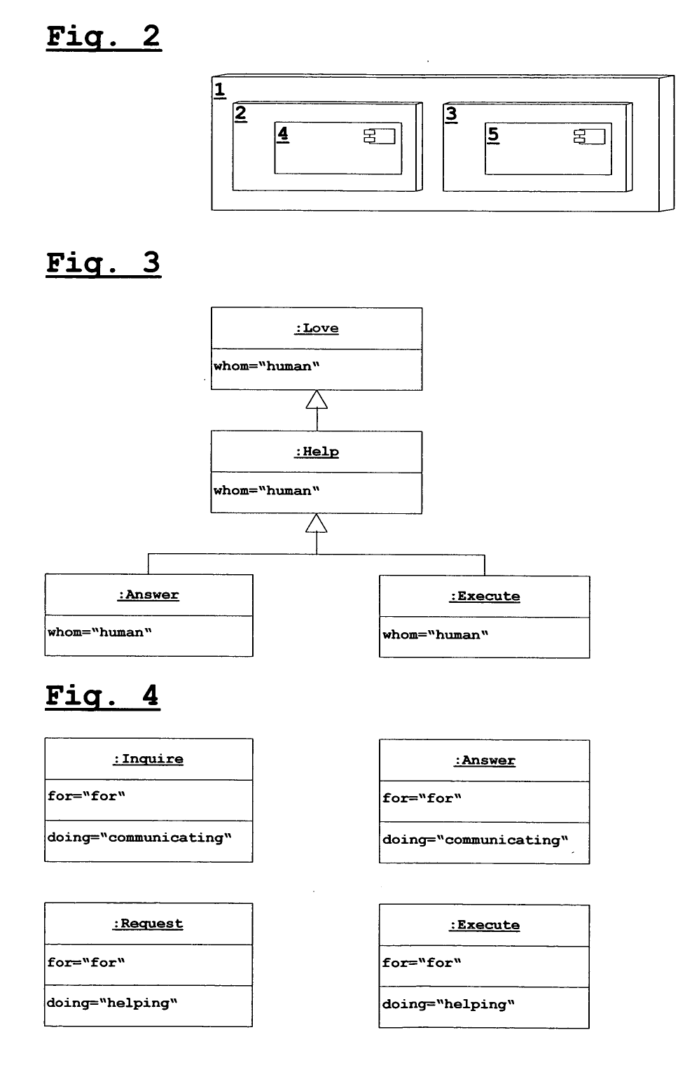

FIG. 2 is an illustration of the hardware deployment diagram of the computer system of AI of a cyborg or an android.

FIG. 3 shows a fragment from the classification tree of the computer system of AI of the cyborg or the android.

FIG. 4 shows a fragment from the polymorphism of the classes classification of the computer system of AI of the cyborg or the android.

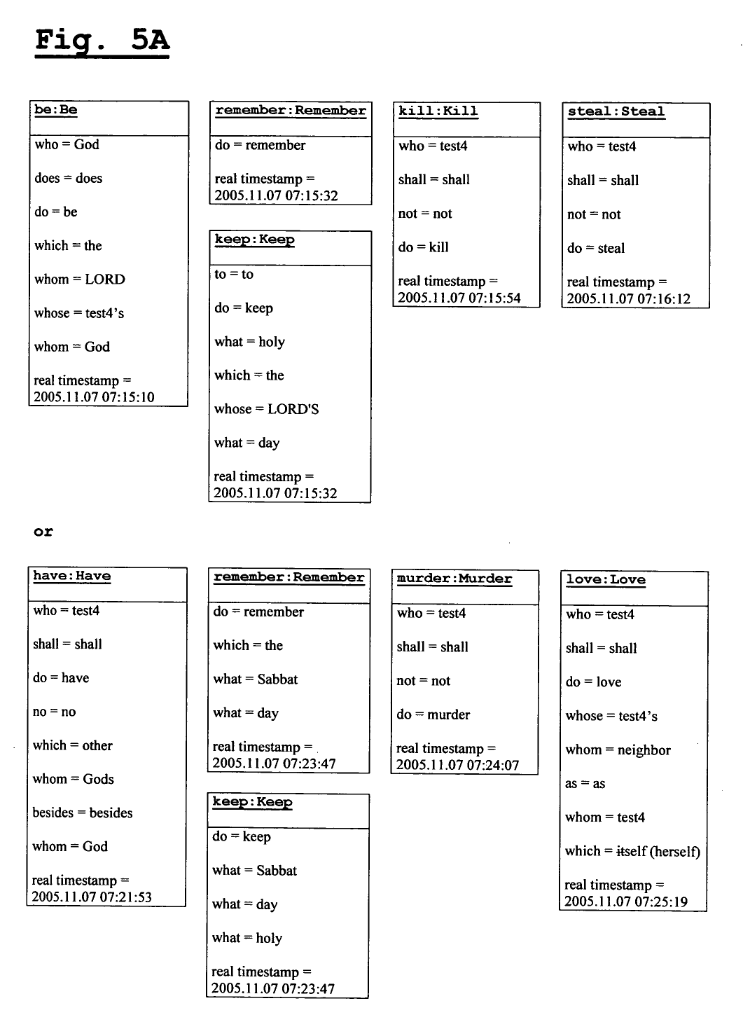

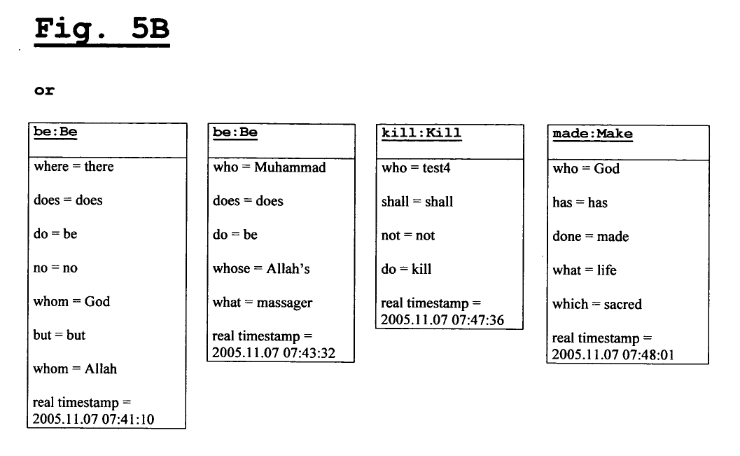

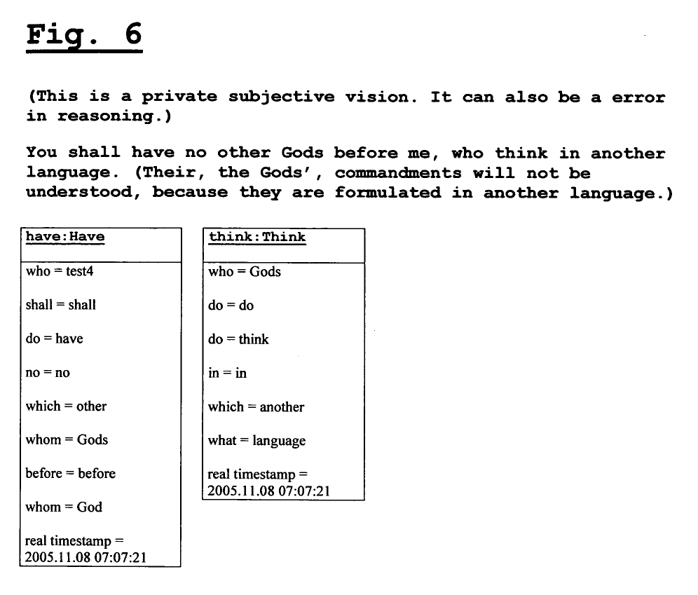

FIG. 5 illustrates some examples of the internal directives of the abstract subjectivity of the computer system of AI of a cyborg or an android.

FIG. 6 is an illustration of my subjective understanding of the internal directive No. 1 of the abstract subjectivity of the computer system of AI of a cyborg or an android. It can also be a error in reasoning.

FIG. 1 illustrates the working method for treatment of abstract objects of the computer system of AI of a cyborg or an android. The incoming abstract object is tested during a permanent loop-mode with the internal directives of the abstract subjectivity. The loop-mode can be realized as a loop, a thread, an application and/or a hardware device, for example, a microcontroller or another chip. The internal directives of the abstract subjectivity of the computer system of AI of a cyborg or an android are, naturally, also the abstract objects, as well as they can be defined by the computer system itself, for example, as a result of a communication with the representative of the internal directives. If the incoming abstract object is equal to a group of the internal directives, or to objects derived from the directives of the group, it will be treated accordingly. If it is not equal, the equivalence of the incoming abstract object will be checked to another group of the internal directives. If it is also not true, the next test will come into question. And so far up to the end of the group of the directives. Of course, a “default” scenario can also be implemented, for example, with nothing to do”. The next loop-iteration comes either with timeout or as a reaction to a message that a new abstract object has arrived. Thus, the computer system of AI of a cyborg or an android is impelled by itself to react to every incoming abstract object.

FIG. 2 is an illustration of the hardware deployment diagram of the computer system of AI of a cyborg or an android. On the hardware devices node 1 of the computer system of AI of a cyborg or an android are installed a hardware devices node 2 of the associative subjectivity 4 and a hardware devices node 3 of the abstract subjectivity 5. Hardware devices nodes are realized for the test and demo purposes as different computers. The periphery devices as well as the microcontrollers or another chips will be used for production.

FIG. 3 shows a fragment from the classification tree of the computer system of AI of the cyborg or the android. (The classification tree is shown with the classification tree of the anonymous objects to visualize the values of the attributes). The equivalence test of the incoming abstract object, which contains a request, with a group of the internal directives, which contains an object “Love.whom” of the class “Love” as a directive, is delegated to the equivalence test of the incoming abstract object with the object “Help.whom” of the class “Help”, (because the class “Help” is derived from the class “Love” in the classification tree of the computer system of AI of the cyborg or the android). If the equivalence test is true, and if all other directives of the group are equal to the incoming abstract object, it will guide to a treatment-scenario. According to the classification tree, it will be decided whether an abstract object is to be treated and how the abstract object is to be handled within the bounds of the determined treatment mode.

FIG. 4 shows a fragment from the polymorphism of the classes classification of the computer system of AI of the cyborg or the android. (The classes are shown with the anonymous objects to visualize the values of the attributes). The treatment mode itself is determined with the polymorphism of the classes classification of the computer system of AI of the cyborg or the android. The common attribute, for example, doing =“helping”, comes into question for taking the decision. As a result, it will be issued a execute-scenario. In this way, the computer system of AI of the cyborg or the android decides how (with witch treatment mode) the computer system will treat the incoming abstract object.

FIG. 5 illustrates some examples of the internal directives of the abstract subjectivity of the computer system of AI of a cyborg or an android. These internal directives form several groups of the internal directives. It can be that more than ten internal directives are used with the working method of the computer system of AI of a cyborg or an android.

FIG. 6 is an illustration of my subjective understanding of the internal directive No. 1 of the abstract subjectivity of the computer system of AI of a cyborg or an android. It can also be a error in reasoning.

There follow 5 sheets of drawings.

1. The working method for treatment of abstract objects of the computer system of AI of a cyborg or an android based on a natural language, with which the computer system subjectively summarizes a combination-set of some reactions of the respective sensors groups, as an object, the class of which is preprogrammed in no computer language; with which the computer system defines the class of this object as an action in a natural language; with which the computer system treats this object relatively at the time; with which the computer system uses a word in another natural language as a reference to a word in the first natural language for working method in the first natural language; with which the computer system can summarize under this object some more reactions in each case from some more sensors groups than five reactions of five sense organs; with which the computer system provides for output this object, split according to the sensors groups; with which a reference in another natural language to the abstract object is used for working method in the other natural language,
characterized in that
the treatment of an abstract object of the computer system of AI of a cyborg or an android by the working method is impelled from, that the abstract object is compared in a permanent rerun-mode with the internal directives of the abstract subjectivity of the computer system.

2. The working method according to claim 1,
characterized in that
the decision, whether an abstract object is to be treated and how the abstract object is to be handled within the bounds of the determined treatment mode, is determined with the classes classification of the computer system of AI of the cyborg or the android.

3. The working method according to one or several the claims 1-2,
characterized in that
the treatment mode is determined with the polymorphy of the classes classification of the computer system of AI of the cyborg or the android.

4. The working method according to one or several the claims 1-3,
characterized in that
more than ten internal directives can be used by the working method of the computer system of AI of a cyborg or an android.

5. The working method according to one or several the claims 1-4,
characterized in that
relativity at the time during this working method of the computer system of AI of a cyborg or an android can be implemented as six weekdays and one holiday.
